(19) United States
(12) Patent Application Publication
(10) Pub. No.: US 2009/0047514 A1
(43) Pub. Date: Feb. 19, 2009

(54) Thermal Activated Pressure Sensitive Adhesive and Method for Producing the Same and Product therewith

(76) Inventors: David P. Allen, Bridgeport, WV (US); Daniel Peters, Hamilton, OH (US)

Correspondence Address: A PATENT LAWYER CORP, PLC;R WILLIAM GRAHAM, 22 S ST CLAIR ST, DAYTON, OH, 45402, US

(21) Appl. No.: 11/838,913

(22) Filed: Aug. 15, 2007

(51) Int. Cl. B32B 7/12; B05B 5/00; B05C 11/00; C08J 3/02; B05D 5/10

(52) U.S. Cl. 428/346; 118/40; 118/641; 427/208.2; 524/457

(57) ABSTRACT

A thermally activated pressure sensitive adhesive is provided and a substrate includes the thermally activated pressure sensitive adhesive applied to one side of thereof. A method and system for include forming a pressure sensitive adhesive coated substrate using a thermally activated pressure sensitive adhesive coated substrate.

### BACKGROUND OF THE INVENTION

1. Field of the Invention

The present invention relates to improvements in thermally activated adhesives. More particularly, the invention relates to a thermally activated pressure sensitive adhesive and method for producing the same and a product employing the same.

2. Description of the Related Art

There exist thermally activated adhesive products which employ an adhesive which upon being heated the adhesive becomes active and is capable of being adhered for a single usage. These are commonly referred to as thermally activated adhesives.

There are also peel-and-stick self-adhesive labels used for indication of bar codes, prices and the like are of a type which includes a pressure-sensitive adhesive layer laid over a back side of a receiving surface (printable surface) and a release sheet (separator) affixed thereto for storage. Pressure-sensitive adhesive (PSA) labels are useful for many applications in which on-demand labels are required, as at grocery stores. However, conventional PSA labels produce waste because they require release sheets which must be removed from the pressure-sensitive adhesive layers before the self-adhesive labels are used.

One attempt to solve the waste problem is to employ a system which does away with the release sheet. A heat-sensitive self-adhesive label includes a label-like substrate and a heat-sensitive adhesive layer which is formed on a back side of the substrate and which normally presents a non-adhesion property but develops an adhesion property when heated, and uses a thermal activation device for developing the adhesion property of the heat-sensitive adhesive layer by heating. Unfortunately, this attempt fails to meet the needs in the industry because the heat formed product provides a label which is capable of single application. Thus, if the label is improperly applied, the adhesive does not permit ready removal and reattachment.

Many heating systems were also contemplated for dealing with the activated adhesive. These can include infrared radiation system, hot air heating system, a heat roll system, induction coil heating system, for example. The focus of the prior art was to try various types of heating systems to avoid the problem of leaving a residual of the activated adhesive on the heating equipment.

The present invention is an improvement over the art and obviates the aforementioned problems.

### SUMMARY OF THE INVENTION

It an object to improve thermally activated adhesives.

It is a further object to provide a thermally activated pressure sensitive adhesive.

Another object is to provide a substrate having a thermally activated pressure sensitive adhesive.

It is an object of the invention to provide method of forming a substrate having a thermally activated pressure sensitive adhesive.

A further object is to provide a pressure sensitive adhesive product by thermal activation.

Accordingly, the instant invention therefore is directed to a thermally activated pressure sensitive adhesive which includes acrylic latex, one or more monomer, a tackifier dispersion agent, a plasticizer, a wetting agent/surfactant and can preferably include a defoamer. A thermally activated pressure sensitive adhesive substrate can be formed by providing a plastic film or paper and coating a thermally activated pressure sensitive adhesive thereon. A method of forming a pressure sensitive adhesive coated substrate includes providing a substrate having a thermally activated pressure sensitive adhesive coated thereon and heating the substrate having a thermally activated pressure sensitive adhesive coated thereon to form the pressure sensitive adhesive coated substrate.

The invention provides a heater for thermal activating a thermally activated pressure sensitive adhesive layer of a substrate having a sheet-like substrate formed with a printable surface on one side thereof and with the thermally activated pressure sensitive adhesive layer on the other side thereof and a conveyor for conveying the substrate having the thermally activated pressure sensitive adhesive thereon in a predetermined direction past the heater in a manner to perform thermal activation of the thermally activated pressure sensitive adhesive layer. A cooling device, such as a fan, can be operably disposed opposed the heater to keep the print receptive side from blacking.

Thus, provided is a substrate having thermally activated pressure sensitive adhesive thereon includes a sheet-like substrate formed with a thermally activated pressure sensitive adhesive layer on one side thereof normally presenting a non-adhesion property but developing a pressure sensitive adhesion property when heated which can be used as a removable peel-and-stick self-adhesive label. The invention will be more fully understood from reading the following description and viewing the drawings hereinafter provided.

### BRIEF DESCRIPTION OF THE DRAWINGS

For a better understanding of the present invention, reference is made of a detailed description to be read in conjunction with the accompanying drawings, in which:

FIG. 1 is a schematic diagram showing an exemplary arrangement of the invention.

FIG. 2 is a blow up of a portion of a substrate in FIG. 1.

FIG. 3 is a schematic diagram showing another exemplary arrangement of the invention.

### DETAILED DESCRIPTION OF THE PREFERED EMBODIMENT

Referring now to the drawings, the thermally activated pressure sensitive adhesive of the present invention is generally referred to by the number 10. The TAPSA 10 does not have tack at ambient temperature, which allows it to be coated onto a paper or plastic film substrate and wound up into rolls without silicone release liners. When the coated paper or film is to be used as a label, for example, the adhesive is activated at elevated temperature. After activation, the adhesive has good pressure sensitive adhesive properties (tack and peel). The thermally activated pressure sensitive adhesive (TAPSA) 10 can be applied to a side 14 of a substrate 12 which can be in the form of a paper or plastic film substrate, for example. The substrate 12 can preferably include another side 16 which is print receptive.

The thermally activated pressure sensitive adhesive 10 can include an acrylic latex such as butyl acrylate, 2-ethylhexyl acrylate, n-octyl acrylate, for example, in an effective amount from about 5% to 40%. Monomers can be provided which can include vinyl acetate, styrene, acrylic acid, methacrylic acid, methyl acrylate or ethyl acrylate in an effective amount from about 2% to 30%. A dispersion such as rosin ester dispersions can include glycerol ester of hydrogenated rosin, pentaerythritol ester of hydrogenated gum rosin or similar tackifier dispersions in an effective amount from about 10% to 40%. Solid plasticizer can be provided and can include neopentyl glycol dibenzoate, sucrose benzoate, dicyclohexyl phthalate, pentaerythritol tetrabenzoate or glycerol tribenzoate, for example, in an effective amount from about 5% to 50%.

A wetting agent/surfactant can be provided such as dioctyl sodium sulfosuccinate, nonyl phenol ethoxylates, octyl phenol ethoxylates, linear alcohol ethoxylates, acetylenic diols, alkylbenzene sulfonates, alkyl sulfates, alkyl ether sulfates, ethoxylated alkanolamides, glycol esters or polyethylene glycol esters in an effective amount from about 0.2% to 2%. Also, a defoamer can be provided and can include a hydrocarbon which is oil-based such as vegetable oils and silicone oil as well as silica fillers and similar blends in an effective amount from about 0.1% to 2%.

Each of the ingredients in the TAPSA 10 plays a role that makes it work as a heat activated pressure sensitive adhesive. The acrylic latex has some pressure sensitive properties. Upon heat activation, it fuses with the tackifier resin resulting in a polymer matrix composition that has high tack. Polyvinyl acetate, for example, has a glass transition temperature around 35° C. At ambient temperature, the polymer does not have appreciable tack. At the activation temperature, this component melts and mixes with the acrylic resin and the tackifier resin to provide greater cohesive or internal strength. The solid plasticizer, such as dicyclohexyl phthalate, is thought to be a key ingredient in one formulation. Its presence in the composition eliminates any tack of the adhesive at ambient temperature. The melting point of the dicyclohexyl phthalate is 63 to 65° C. When the adhesive is heat activated above the melting point of this plasticizer it becomes liquid and allows the polymer/tackifier matrix to become active resulting in pressure sensitive adhesive properties. The wetting agent is provided to lower surface tension and allows the water-based composition to be coated on different substrates. The defoamer eliminates the generation of foam during processing.

The invention provides a highly suitable product which requires minimal activation time, i.e., it only takes around one second at about 800° C. to activate the TAPSA 10. Once activated, the TAPSA 10 has good tack and peel properties for several hours, allowing it to be easily applied as a label to any substrate.

It is contemplated that various acrylic latexes having pressure sensitive adhesive properties could be used for this invention. This includes acrylic latexes made from butyl acrylate, 2-ethylhexyl acrylate, n-octyl acrylate and the like. The latex compositions can also include lesser amounts of other monomers that do not have tack properties like vinyl acetate, styrene, acrylic acid, methacrylic acid, methyl acrylate and ethyl acrylate.

Preferred levels of the latex polymer in the heat activated adhesive range from 5 to 40%. The level of the polyvinyl acetate latex can range from 2%-30% and the level of the tackifier resins can range from 10 to 40%.

Preferred levels of the dicyclohexyl phthalate plasticizer can range from 25 to 50%. In principle, other solid plasticizers may be useful for this invention as mentioned above. The level of wetting agent can range from 0.2 to 2%. There are numerous other wetting agents and surfactants that can be used in the adhesive. Preferred levels of defoamer range from about 0.1 to 2%. The adhesive can be activated at temperatures above the melting point of the dicyclohexyl phthalate plasticizer (65° C.). Preferred range of activation temperatures are from about 65° to 50° C.

The following are illustrative examples of the invention.

EXAMPLE 1

| | | Dry | Wet |
|---|---|---|---|
| | | Weight | Weight |
| Ingredient | % Solids | Grams | Grams |
| Water | | | 31.9 |
| Dioctyl Ester of | 75 | 1.50 | 2 |
| Sodium | | | |
| Sulfosuccinate | | | |
| Dicyclohexyl | 100 | 25 | 25 |
| Phthalate | | | |
| Polymer Latex | 65 | 6.25 | 9.62 |
| Made From | | | |
| Polyacrylic Acid | | | |
| Esters | | | |
| Polyvinyl | 55 | 12.50 | 22.73 |
| Acetate Ester | | | |
| tackifier Resin | 55 | 12.50 | 22.73 |
| Dispersion Made | | | |
| from a | | | |
| Pentaerythritol | | | |
| Ester of | | | |
| Hydrogenated | | | |
| Wood Rosin | | | |
| Hydrocarbon Oil | 100 | 0.47 | 0.47 |
| Based Liquid | | | |
| Defoamer | | | |
| Totals | 50.87 | 58.22 | 114.45 |

EXAMPLE 2

| | | Dry | Wet |
|---|---|---|---|
| | | Weight | Weight |
| Ingredient | % Solids | Grams | Grams |
| Water | | | 48.68 |
| Dioctyl Ester of Sodium Sulfosuccinate | 75.00 | 2.00 | 2.67 |
| Dicyclohexyl Phthalate | 100.00 | 35.00 | 35.00 |
| Polymer Latex Made From Polyacrylic | 59.90 | 12.50 | 20.87 |
| Acid Esters | | | |
| Polyvinyl Acetate Latex | 57.20 | 2.00 | 3.50 |
| Tackifier Resin Emulsion Made from the | 53.86 | 18.00 | 33.42 |
| Pentaerythritol Ester of Hydrogenated | | | |
| Gum Rosin | | | |
| Water Dispersible Plasticizer Made by | 93.10 | 2.00 | 2.15 |
| Blending a Soft Rosin Ester with a | | | |
| Naphthenic Process Oil | | | |
| Hydrocarbon OH Based liquid Defoamer | 100.00 | 0.50 | 0.50 |
| Clay Slurry (Dispersion of Kaolin Clay | 70.00 | 6.00 | 8.57 |
| in Water) | | | |
| Polyurethane Associative Thickener and | 10.00 | 0.08 | 0.80 |
| Rheology Control Agent | | | |
| Totals | 50.00 | 78.08 | 156.16 |

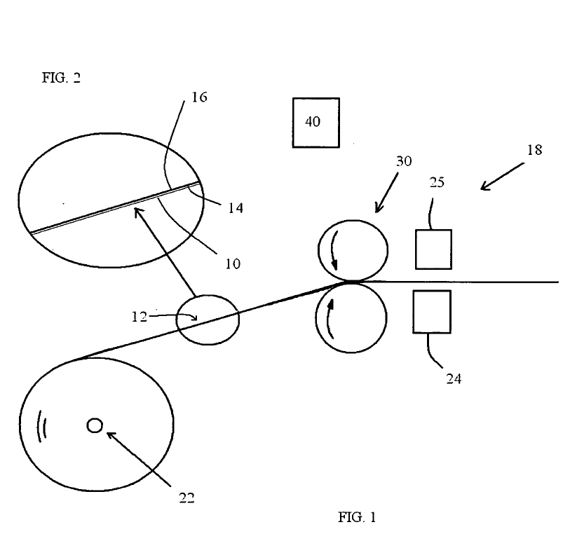

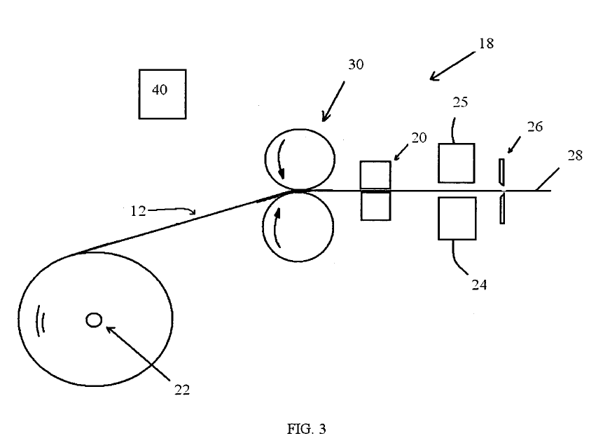

FIGS. 1 and 3 depict schematic diagrams showing arrangements of a thermal activation device 18. FIG. 1 depicts a simple version which includes the substrate 12, container roll 22, heater 24, and conveyor or conventional drive system 30. FIG. 3 depicts additional components of a printer 20 and cutter 26. The roll container 22 holds a roll of the substrate 12 having TAPSA 10 coated thereon. The heater 24, such as a heater coil, can be provided and disposed in a manner to heat the TAPSA 10 after passing through the printer 20. A cooling device 25, such as a fan, can be operably disposed opposed the heater 24 to keep the print receptive side 16 from blacking.

Cutter 26 is provided for cutting a label 28, for example, to a predetermined length. The cutter 26 can include a movable cutting blade operated by a drive source (not shown) such as of an electric motor, and a stationary cutting blade opposed by the movable blade. The configuration of the label 28 used in the embodiment is not limited and may be of any suitable size and shape.

Operably associated with the printer 20 is a conventional drive system 30 for moving the roll of substrate 12 in a predetermined direction thereby unwinding the same and conveying the substrate 12 along the predetermined direction allowing the printer 20 to print thereon prior to heating and cutting.

A CPU 40 having a display unit, such as a touch screen, can be operably connected to the printer 20, heater 24, cutter 26 and drive system 30 for controlling operation of each. The printer 20 performs a desired printing based on a control signal transmitted from the CPU 40. The thermal heater 24 activates the TAPSA 10 for a period based on a signal from the CPU 40. The cutter 26, in turn, performs a cutting operation based upon signals received from the CPU 40. The cutter 26 can be configured to cut entirely through the substrate 12 or in a manner to substantially cut through the substrate 12 such that there are formed lines of separation which readily enables the label 28 to be separated from the remaining portion of the substrate. In this regard, the cutter 26 can be located directly adjacent the heater 24.

The operation of making a label is as follows. The roll of substrate 12 is unwound by the rotation drive system 30 such that the printable surface 16 of the label is passed through the printer 20 wherein print is applied thereto. Subsequently, the substrate 12 is conveyed to the cutter 24 to be cut in a predetermined length by means of the movable blade. Then, the substrate 12 is fed past the thermal heater 24 in a manner to expose the side 14 having the TAPSA 10 thereon thereby thermally activating the same. There is now formed a pressure sensitive adhesive on the substrate 12 which is cut by the cutter 26 to form PSA label 28.

The drive system 30 can include rollers or other feed directors such that the substrate 12 is maintained under the control of the drive system 30 to an area proximate the cutting of the substrate 12. When the substrate 12 is cut, the formed label 28 is disposed in a manner to be retrieved by the user.

Thus, provided is a substrate having thermally activated pressure sensitive adhesive thereon which includes a sheet-like substrate formed with a thermally activated pressure sensitive adhesive layer on one side thereof normally presenting a non-adhesion property but developing a pressure sensitive adhesion property when heated which can be used as a removable peel-and-stick self-adhesive label. The invention accomplished by the inventors has been specifically described with reference to the embodiments thereof. However, it is to be noted that the invention is not limited to the above embodiments and various modifications and changes may be made thereto within the scope of the invention. It is contemplated that the invention can have application for use in forming other products which could use a TAPSA material formed thereon. By so providing the instant invention, there is no longer a need to provide various cleaning means for removing activated heat-sensitive adhesive as with prior technology. The invention therefore not only accomplishes the objective of obviating the need for a release liner but also reduces labor and eliminates nuisance of cleaning required with prior thermally activated adhesive technology.

What is claimed is:

1. A thermally activated pressure sensitive adhesive substrate, which includes:
a substrate having a first side and a second side; and
a thermally activated pressure sensitive adhesive applied to said first side.

2. The thermally activated pressure sensitive adhesive substrate of claim 1, wherein said substrate includes one of a plastic film and paper.

3. The thermally activated pressure sensitive adhesive substrate of claim 1, wherein said substrate is a label.

4. A method of forming a pressure sensitive adhesive coated substrate includes the steps of:
(a) providing a substrate having a thermally activated pressure sensitive adhesive coated thereon and
(b) heating said substrate having said thermally activated pressure sensitive adhesive coated thereon to cause activation of said thermally activated pressure sensitive adhesive thereby forming said pressure sensitive adhesive coated substrate.

5. The method of claim 4, which includes the step of printing on said substrate.

6. The method of claim 4, which includes the step of cutting said substrate to form a label.

7. The method of claim 6, which includes the step of printing on said substrate.

8. A system for forming a pressure sensitive adhesive coated substrate, which includes:
a substrate having a thermally activated pressure sensitive adhesive layer coated thereon;
heating means for thermally activating said thermally activated pressure sensitive adhesive layer by heating; and
means for conveying said substrate in a predetermined direction past said heating means in a manner to permit said thermally activating of the thermally activated pressure sensitive adhesive layer.

9. The system of claim 8, which includes means for cutting said substrate to a predetermined length.

10. The system of claim 8, which includes means for printing on said substrate.

11. The system of claim 8, which includes computer based means for controlling said heating means and said conveying means.

12. The system of claim 9, which includes computer based means for controlling said heating means, said conveying means and said cutting means.

13. The system of claim 10, which includes computer based means for controlling said heating means, said conveying means and said printing means.

14. The system of claim 8, which includes means disposed opposing said heater for cooling said substrate.

15. A thermally activated pressure sensitive adhesive, which includes acrylic latex, one or more monomer, a tackifier, a dispersion agent, a plasticizer, a wetting agent/surfactant and a defoamer.

16. The thermally activated pressure sensitive adhesive of claim 15, wherein said latex is present in a range from about 5 to 40%, said tackifier resins is present in a range from about 10 to 40%, said dispersion agent is present in a range from about 0.2 to 2% and said defoamer is present in a range from about 2% to 30%.

17. The thermally activated pressure sensitive adhesive substrate of claim 1, wherein said thermally activated pressure sensitive adhesive is characterized to include a composition applied to said first side which when applied does not include a pressure sensitive adhesive and is characterized such that upon exposure to a predetermined temperature converts said composition to a thermally activated pressure sensitive adhesive.

18. The thermally activated pressure sensitive adhesive substrate of claim 17, wherein said thermally activated pressure sensitive adhesive includes acrylic latex, one or more monomer, a tackifier, a dispersion agent, a plasticizer, a wetting agent/surfactant and a defoamer.
